(19) United States
(12) Patent Application Publication
(10) Pub. No.: US 2020/0264602 A1
(43) Pub. Date: Aug. 20, 2020

(54) UNMANNED AERIAL VEHICLE SYSTEM AND COMMUNICATION METHOD

(71) Applicant: SZ DJI TECHNOLOGY CO., LTD., Shenzhen (CN)

(72) Inventors: Ning MA, Shenzhen (CN); Ying CHEN, Shenzhen (CN); Dong ZHANG, Shenzhen (CN)

(21) Appl. No.: 16/865,815

(22) Filed: May 4, 2020

Related U.S. Application Data
(63) Continuation of application No. PCT/CN2017/113923, filed on Nov. 30, 2017.

(51) Int. Cl. G05D 1/00; G05D 1/10; B64C 39/02; H04W 4/40; H04W 4/80

(52) U.S. Cl. CPC G05D 1/0022; G05D 1/101; B64C 2201/127; H04W 4/40; H04W 4/80; B64C 39/024

(57) ABSTRACT

An unmanned aerial vehicle includes a camera, a first communication system, a second communication system, and a controller. The camera captures images or videos. The first communication system communicates according to a proprietary protocol. The second communication system communicates according to a standard communication protocol. The controller controls operations of the first communication system and the second communication system, to allow the first communication system and the second communication system to simultaneously transmit an image or video captured by the camera.

### CROSS-REFERENCE TO RELATED APPLICATION

This application is a continuation application of International Application No. PCT/CN2017/113923, filed on Nov. 30, 2017, the entire content of which is incorporated herein by reference.

### TECHNICAL FIELD

The present disclosure relates to the field of data communication and, more particularly, to an unmanned aerial vehicle system and a corresponding communication method.

### BACKGROUND

Currently, unmanned aerial vehicles (UAVs) with cameras are widely used. For example, a UAV with one or more cameras may track and capture a desired object and transmit the captured images and/or videos to a user in real-time through wireless communication.

In addition, with the popularity and development of the Internet self-media and the like, after using UAVs for aerial photography, people often want to download media data to their mobile phones right away and upload them to the Internet through editing.

With the improvement of the image quality of the cameras carried by the UAVs, the size of the videos and images taken by the cameras becomes larger and larger. This puts high demands on the instant transmission of image data and video data of the UAVs.

### SUMMARY

In accordance with the present disclosure, there is provided an unmanned aerial vehicle. The unmanned aerial vehicle includes a camera, a first communication system, a second communication system, and a controller. The camera is configured to capture an image or video. The first communication system is configured to communicate according to a proprietary protocol, and the second communication system is configured to communicate according to a standard communication protocol. The controller is configured to control operations of the first communication system and the second communication system, to allow the first communication system and the second communication system to simultaneously transmit the image or video captured by the camera.

Also in accordance with the disclosure, an unmanned aerial vehicle system is provided. The unmanned vehicle system includes an unmanned aerial vehicle and a remote control. The unmanned aerial vehicle includes a camera, a first communication system, a second communication system, and a controller. The camera is configured to capture an image or video. The first communication system is configured to communicate according to a proprietary protocol, and the second communication system is configured to communicate according to a standard communication protocol. The controller is configured to control operations of the first communication system and the second communication system, to allow the first communication system and the second communication system to simultaneously transmit the image or video captured by the camera. The remote control is configured to receive the image or video, captured by the camera, from the unmanned aerial vehicle by communicating with the first communication system and/or the second communication system of the unmanned aerial vehicle.

Also in accordance with the disclosure, a method implemented by an unmanned aerial vehicle is provided. The unmanned aerial vehicle includes a camera, a first communication system, a second communication system, and a controller. The method includes that: the camera captures an image or video; the first communication system communicates according to a proprietary protocol; the second communication system communicates according to a standard communication protocol; and the controller controls operations of the first communication system and the second communication system, to allow the first communication system and the second communication system to simultaneously transmit the image or video captured by the camera.

### BRIEF DESCRIPTION OF THE DRAWINGS

FIG. 1 is a block diagram of a UAV according to an embodiment of the present disclosure.

FIG. 2 is a flowchart of a method performed by a UAV according to an embodiment of the present disclosure.

FIG. 3 is a block diagram of a UAV system according to an embodiment of the present disclosure.

FIG. 4 is a flowchart of a method performed by a UAV system according to an embodiment of the present disclosure.

FIG. 5 is a schematic diagram of a computer-readable storage medium according to an embodiment of the present disclosure.

FIG. 6 is a schematic diagram of a data communication of a UAV according to an embodiment of the present disclosure.

### DETAILED DESCRIPTION

The disclosure is described in detail hereinafter with reference to the drawings and specific embodiments. It should be noted that the present disclosure should not be limited to the specific embodiments described therein. In addition, for the sake of simplicity, detailed descriptions of well-known technologies not directly related to the present disclosure are omitted to prevent confusion in the understanding of the present disclosure.

The principles of the present disclosure may be applied to UAVs having two or more communication systems, wherein at least one communication system may communicate according to a proprietary protocol and at least another communication system may communicate according to a standard communication protocol. In the following embodiments, the principles of the present disclosure will be described in detail with a UAV having two communication systems: one is a communication system that communicates according to a proprietary image transmission protocol, and the other is a communication system that communicates according to a WiFi communication protocol. However, those skilled in the art may understand that the principles of the present disclosure may also be applied to UAVs/UAV systems having two or more communication systems adopting other types of proprietary protocols and standard communication protocols.

### Unmanned Aerial Vehicle and Corresponding Method

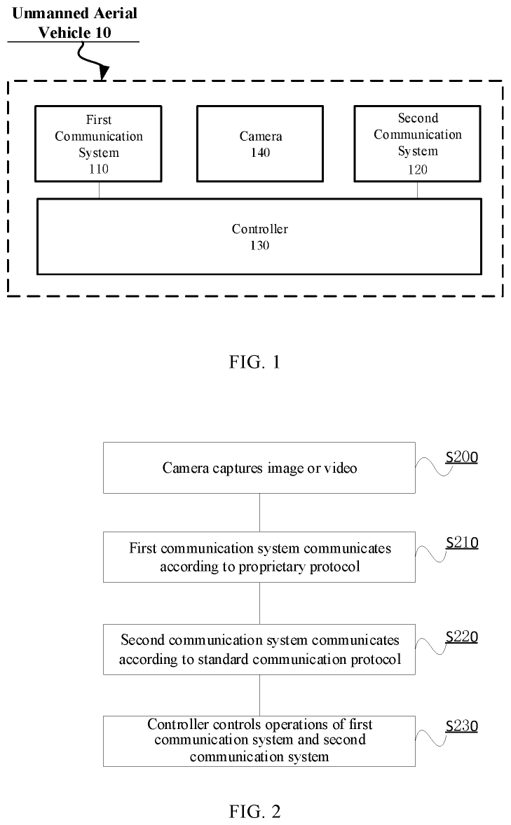

FIG. 1 is a block diagram illustrating a UAV according to an embodiment of the present disclosure. As shown in FIG. 1, a UAV 10 includes a first communication system 110, a second communication system 120, a controller 130, and a camera 140.

The first communication system 110 is configured to communicate according to a proprietary protocol. For example, the first communication system 110 may communicate with a remote control or user device according to a proprietary image transmission protocol to transmit information such as image/video data and/or signaling. In the disclosed embodiments, the proprietary image transmission protocol may be an Ocusync communication protocol.

The second communication system 120 is configured to communicate according to a standard communication protocol. For example, the second communication system 120 may communicate with a remote control or user device according to a WiFi communication protocol to transmit information such as image/video data and/or signaling.

The camera 140 is configured to capture an image or a video. For example, the camera 140 may include one or more cameras, which may be visible light cameras and/or infrared cameras, and so on.

The controller 130 is configured to control operations of the first communication system 110 and the second communication system 120, to allow the first communication system 110 and the second communication system 120 to simultaneously transmit images or videos captured by the camera 140.

For example, the controller 130 may be configured to control the operations of the first communication system 110 and the second communication system 120, to allow one of the first communication system 110 and the second communication system 120 to transmit an image or video captured by the camera 140 to a first device, and allow the other of the first communication system 110 and the second communication system 120 to transmit an image or video captured by the camera 140 to a second device.

Here, the first device may include, for example, a remote control for controlling the UAV 10. The second device may include, for example, a user device having an application capable of communicating with the first communication system 110 or the second communication system 120. For example, the user device may be a mobile phone.

The controller 130 may use various methods to control the first communication system 110 and the second communication system 120 to operate in a full-duplex manner. An example of such a control method is the use of multipath transmission control protocol (MPTCP). Specifically, according to the MPTCP, the controller 130 may perform operations such as connection initialization, data mapping, data transmission and retransmission, congestion control, and link management for a proprietary communication link provided by the first communication system 110 and a standard communication link provided by the second communication system 120. This allows the first communication system 110 and the second communication system 120 to operate simultaneously in a full-duplex manner without affecting each other. In this way, because the bandwidths provided by the two communication systems may be utilized at the same time, the speed of data transmission is greatly improved, and the accuracy of data transmission is also ensured.

Optionally, the first communication system 110 and the second communication system 120 may work in different frequency bands so as not to interfere with each other in a full-duplex communication process. For example, if the first communication system 110 communicates according to the OcuSync proprietary image transmission protocol and the second communication system 120 communicates according to the WiFi communication protocol, then the communication implemented according to the OcuSync proprietary image transmission protocol may use a 5.8 GHz frequency band, while the communication implemented according to the WiFi communication protocol may use a 2.4 GHz frequency band. Alternatively, the communication implemented according to the OcuSync proprietary image transmission protocol may use a 2.4 GHz frequency band, while the communication implemented according to the WiFi communication protocol may use a 5.8 GHz frequency band, and so on.

By adoption of the technical solutions of the disclosed embodiments, the communication bandwidth of the UAVs may be increased, and the transmission speed of the image/video data may be improved.

FIG. 2 is a flowchart illustrating a method performed by a UAV according to an embodiment of the present disclosure. For example, the method may be performed by the UAV 10 including the first communication system, the second communication system, the controller, and the camera shown in FIG. 1.

Each part of the method in FIG. 2 is made in detail hereinafter. It should be noted that the various parts (blocks) of the method need not be executed in the order shown in the figure. Rather, these parts may be executed in a different order, and executed independently and/or in parallel.

At block S200, the camera of the UAV captures an image or video. For example, the camera may include one or more cameras, which may be visible light cameras and/or infrared cameras, and so on. Accordingly, the captured images or videos may be visual and/or infrared images and/or videos.

At block S210, the first communication system of the UAV communicates according to a proprietary protocol. For example, the first communication system may communicate with a remote control or user device according to the Ocusync proprietary image transmission protocol.

At block S220, the second communication system of the UAV communicates according to a standard communication protocol. As described above, the second communication system may communicate with a remote control or user device according to the WiFi communication protocol.

At block S230, the controller of the UAV controls the operations of the first communication system and the second communication system, so that the first communication system and the second communication system simultaneously transmit images or videos captured by the camera of the UAV.

For example, the controller may control the operations of the first communication system and the second communication system such that one of the first communication system and the second communication system transmits an image or video captured by the camera to a first device, and the other of the first communication system and the second communication system transmits an image or video captured by the camera to a second device.

Here, the first device may include, for example, a remote control for controlling the UAV. The second device may include, for example, a user device having an application capable of communicating with the first communication system or the second communication system. For example, the user device may be a mobile phone.

The controller may use a variety of methods to control the first communication system and the second communication system to operate in a full-duplex manner. As described above, according to the MPTCP, the controller may perform operations such as connection initialization, data mapping, data transmission and retransmission, congestion control, and link management for a proprietary communication link provided by the first communication system and a standard communication link provided by the second communication system, to allow the first communication system and the second communication system to operate simultaneously in a full-duplex manner without affecting each other.

In some embodiments, the first communication system and the second communication system operate on different frequency bands. For example, the first communication system may communicate using a frequency band of 5.8 GHz, and the second communication system may communicate using a frequency band of 2.4 GHz, and vice versa.

### Unmanned Aerial Vehicle System and Corresponding Method

In the above, a UAV and a method performed by the UAV according to an embodiment of the present disclosure have been described. In the following, a UAV system including a UAV and a corresponding remote control and a method performed by the UAV system are described in detail.

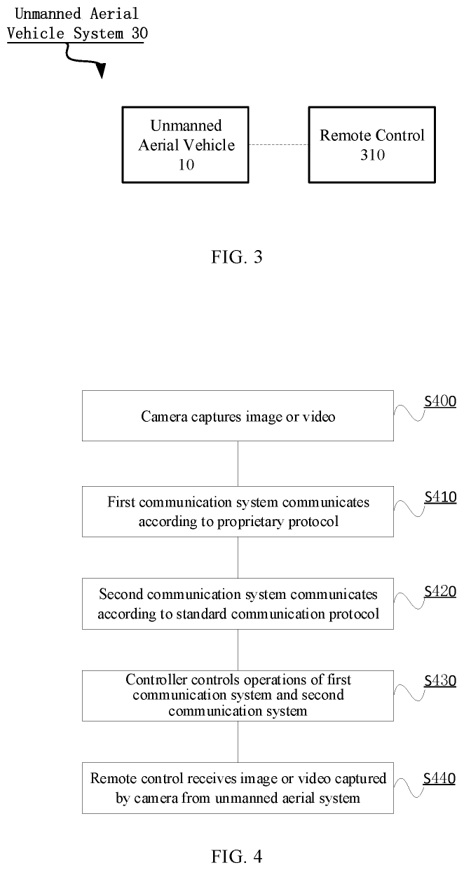

FIG. 3 is a block diagram illustrating a UAV system according to an embodiment of the present disclosure. As shown in FIG. 3, the UAV system 30 includes a UAV 10 and a remote control 310. The UAV 10 may be a UAV 10 shown in FIG. 1. Operations of each component in the UAV system 30 shown in FIG. 3 is described in detail hereinafter.

The UAV 10 may include the first communication system 110, the second communication system 120, the controller 130, and the camera 140, as shown in FIG. 1. As described above, the first communication system 110 may be configured to communicate according to a proprietary protocol (such as the Ocusync proprietary image transmission protocol), and the second communication system 120 may be configured to communicate according to a standard communication protocol (such as a WiFi communication protocol). The camera 140 may be configured to capture images or videos. For example, the camera 140 may include one or more cameras, which may be visible light cameras and/or infrared cameras, and so on.

The controller 130 in the UAV 10 may be configured to control operations of the first communication system 110 and the second communication system 120 such that the first communication system 110 and the second communication system 120 simultaneously transmit images or videos captured by the camera 140.

For example, the controller 130 may be configured to control the operations of the first communication system 110 and the second communication system 120 such that one of the first communication system 110 and the second communication system 120 transmits an image or video captured by the camera 140 to the remote control 310, and the other of the first communication system 110 and the second communication system 120 transmits an image or video captured by the camera 140 to a second device.

The remote control 310 may be configured to receive, from the UAV 10, an image or video captured by the camera 140 by communicating with the first communication system 110 and/or the second communication system 120 of the UAV 10. Further, the remote control 310 may send an image or video, received from the UAV, to the second device; or receive, from the second device, an image or video received by the second device from the UAV.

Here, the second device may include, for example, a user device having an application capable of communicating with the first communication system 110 or the second communication system 120. For example, the user device may be a mobile phone.

The controller 130 may use various methods to control the first communication system 110 and the second communication system 120 to operate in a full-duplex manner, such as using the MPTCP as described above.

In some embodiments, the first communication system 110 and the second communication system 120 of the UAV 10 may work in different frequency bands so as not to interfere with each other in a duplex communication process. For example, the first communication system 110 may use a frequency band of 5.8 GHz for communication, while the second communication system 120 may use a frequency band of 2.4 GHz for communication, and vice versa.

FIG. 4 is a flowchart illustrating a method performed by a UAV system according to an embodiment of the present disclosure. For example, the method may be performed by a UAV system including the UAV and the remote control shown in FIG. 3.

Each part of the method in FIG. 4 is described in detail hereinafter. It should be noted that the various parts (blocks) of the method need not be executed in the order shown in the figure. Rather, these parts may be executed in a different order and independently and/or in parallel.

At block S400, the camera of the UAV captures an image or video. As mentioned above, the camera may include one or more cameras, which may be visible light cameras and/or infrared cameras, and so on.

At block S410, the first communication system of the UAV communicates according to a proprietary protocol. For example, the first communication system may communicate with the remote control or user device according to the Ocusync proprietary image transmission protocol.

At block S420, the second communication system of the UAV communicates according to a standard communication protocol. As described above, the second communication system may communicate with the remote control or user device according to a WiFi communication protocol.

At block S430, the controller of the UAV controls the operations of the first communication system and the second communication system, so that the first communication system and the second communication system simultaneously transmit the images or videos captured by the camera.

For example, the controller may control the operations of the first communication system and the second communication system such that one of the first communication system and the second communication system transmits an image or video captured by the camera to the remote control, and the other of the first communication system and the second communication system transmits an image or video captured by the camera to the second device.

At block S440, the remote control receives an image or video captured by the camera from the UAV by communicating with the first communication system and/or the second communication system of the UAV. Further, the remote control may also send an image or video received from the UAV to the second device, or receive from the second device an image or video received by the second device from the UAV.

Here, the second device may be a user device having an application capable of communicating with the first communication system or the second communication system.

In some embodiments, the first communication system and the second communication system may work on different frequency bands. For example, the first communication system may communicate using a frequency band of 5.8 GHz, while the second communication system may communicate using a frequency band of 2.4 GHz, and vice versa.

### Computer Program Product

Furthermore, the embodiments of the present disclosure may be implemented by means of a computer program product. For example, the computer program product may be a computer-readable storage medium. A computer program is stored on the computer-readable storage medium. When the computer program is executed on a computing device, related operations may be performed to implement the above described technical solutions of the present disclosure.

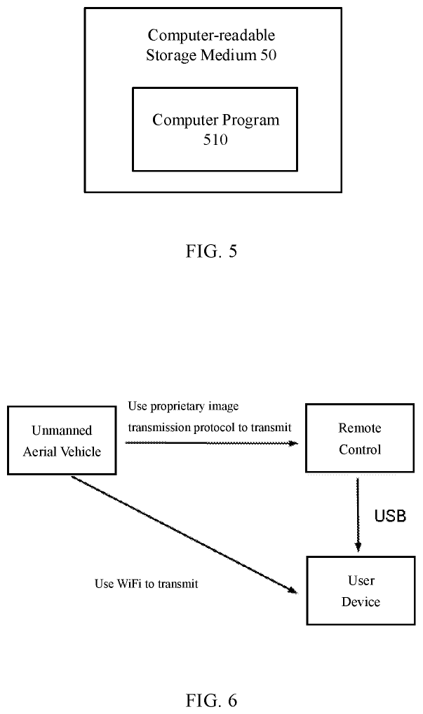

For example, FIG. 5 is a block diagram illustrating a computer-readable storage medium 50 according to an embodiment of the present disclosure. As shown in FIG. 5, the computer-readable storage medium 50 includes a computer program 510. The computer program 510, when executed by at least one processor, causes the at least one processor to perform each part of the methods described, for example, in accordance with FIGS. 2 and 4. Those skilled in the art may understand that examples of the computer-readable storage medium 50 include, but are not limited to, a semiconductor storage medium, an optical storage medium, a magnetic storage medium, or any other form of computer-readable storage medium.

### Example Application Scenario

An example application scenario of the technical solutions of the present disclosure is described hereinafter with reference to FIG. 6.

FIG. 6 is a schematic diagram illustrating a UAV data communication according to an embodiment of the present disclosure. In the application scenario shown in FIG. 6, the UAV (for example, the UAV 10 shown in FIG. 1) communicates with the remote control through a first communication system (e.g., using a proprietary image transmission protocol), and communicates with the user device through a second communication system (e.g., using a WiFi communication protocol).

In FIG. 6, the remote control is illustrated as being connected to the user device through a universal serial bus (USB) interface. However, there are other approaches to connect the remote control to the user device, such as but not limited to, serial port connection, infrared connection, and so on.

As can be seen from FIG. 6, images and/or videos captured by the camera of the UAV may be transmitted to the remote control through a proprietary image transmission protocol, and may be transmitted to the user device through a WiFi communication protocol. For example, the controller in the UAV may control the proprietary image transmission protocol communication and WiFi communication according to the MPTCP, so that the two may work simultaneously without affecting each other. In some embodiments, in order to ensure that WiFi and OcuSync communications do not interfere with each other during communication, a 2.4 GHz frequency band may be used for the WiFi communication, while a 5.8 GHz frequency band may be used for the OcuSync communication. Alternatively, a 2.4 GHz band is used for OcuSync communication, while a 5.8 GHz band is used for the WiFi communication, and so on.

Meanwhile, the remote control may send image and/or video data received from the UAV to the user device via a USB connection. In this way, the user device may combine the image and/or video data it receives from the UAV with the image and/or video data it receives from the remote control to generate the final image(s) and/or video(s) for a display to a user.

It should be noted that although it is shown in FIG. 6 that the remote control sends the image and/or video data it receives from the UAV to the user device, data transmission in the opposite direction is also possible. For example, the user device may send image and/or video data it receives from the UAV to the remote control. In this way, the remote control may also combine the image and/or video data it receives directly from the UAV with the image and/or video data it receives from the user device, so as to generate the final image(s) and/or video(s) and display it to a user (if the remote control includes a display device).

In summary, in the UAV system presented in the present disclosure, the at least two communication systems of the UAV may simultaneously transmit image/video data captured by the UAV. This effectively increases the communication bandwidth, makes the transmission of image/video data faster, and thus greatly improves the user experience.

The methods and related devices of the present disclosure have been described above in conjunction with the specific embodiments. Those skilled in the art may understand that the methods shown above are merely for exemplary purposes. The methods of the present disclosure are not limited to the blocks and orders shown above.

It should be noted that the aforementioned embodiments of the present disclosure may be implemented by software, hardware, or a combination of both software and hardware. Such configuration of the present disclosure is typically provided as software, code, and/or other data structures configured or coded on a computer-readable storage medium such as an optical medium (e.g., CD-ROM), a floppy disk, or a hard drive, or as firmware or microcode on one or more ROM (read-only memory), RAM (random-access memory), PROM (programmable read-only memory) chips, or other storage media, or as downloadable software images and shared databases in one or more modules, etc. Such software, firmware, or configuration may be installed on a computing device, so that one or more processors in the computing device execute the technical solutions described in the embodiments of the present disclosure.

In addition, various functional modules or individual features of the devices used in each of the above embodiments may be implemented or performed by a circuit, which is typically one or more integrated circuits. Circuits designed to implement each function described in this specification may include general purpose processors, digital signal processors (DSPs), application specific integrated circuits (ASICs) or general-purpose integrated circuits, field programmable gate arrays (FPGAs) or other programming logic devices, discrete gate or transistor logic, or discrete hardware components, or any combination thereof. A general-purpose processor may be a microprocessor, or the processor may be an existing processor, controller, microcontroller, or state machine, etc. The general-purpose processor or each circuit may be configured by a digital circuit, or may be configured by a logic circuit. In addition, when an advanced technology capable of replacing a current integrated circuit appears due to advances in the semiconductor technology, the present disclosure may also use such integrated circuits obtained using the advanced technology.

The program running on the devices according to the present disclosure may be a program that causes a computer to implement the functions of the embodiments of the present disclosure by controlling a central processing unit (CPU). The program or the information processed by the program may be temporarily stored in a volatile memory (such as RAM), hard disk drive (HDD), non-volatile memory (such as flash memory), or other storage systems. A program for implementing the functions of the embodiments of the present disclosure may be recorded on a computer-readable recording medium. Corresponding functions may be implemented by causing a computer system to read the program recorded on the recording medium and execute the program. The so-called “computer system” herein may be a computer system embedded in the devices, and may include an operating system or hardware (such as a peripheral device).

As can be seen above, the embodiments of the present disclosure have been described in detail with reference to the drawings. However, the specific structure of the present disclosure is not limited to the foregoing embodiments. The present disclosure also includes any design modifications that do not deviate from the spirits and principles of the present disclosure. In addition, the present disclosure may be modified with different variations within the scope of the appended claims. Embodiments obtained by appropriately combining the technical solutions disclosed in the different embodiments are also included in the technical scope of the present disclosure. In addition, components having the same effects described in the above embodiments may be replaced with each other.

What is claimed is:

1. An unmanned aerial vehicle, comprising:
a camera configured to capture an image or video;
a first communication system configured to communicate according to a proprietary protocol;
a second communication system configured to communicate according to a standard communication protocol; and
a controller configured to control operations of the first communication system and the second communication system, to allow the first communication system and the second communication system to simultaneously transmit the image or video captured by the camera.

2. The unmanned aerial vehicle according to claim 1, wherein:
the controller is further configured to control the operations of the first communication system and the second communication system such that one of the first communication system and the second communication system transmits the image or video captured by the camera to a first device, and the other of the first communication system and the second communication system transmits the image or video captured by the camera to a second device.

3. The unmanned aerial vehicle according to claim 1, wherein:
the first communication system and the second communication system operate on different frequency bands.

4. The unmanned aerial vehicle according to claim 1, wherein:
the proprietary protocol includes an OcuSync communication protocol.

5. The unmanned aerial vehicle according to claim 1, wherein:
the standard communication protocol includes a WiFi communication protocol.

6. The unmanned aerial vehicle according to claim 2, wherein:
the first device includes a remote control for controlling the unmanned aerial vehicle.

7. The unmanned aerial vehicle according to claim 2, wherein:
the second device includes a user device having an application capable of communicating with the first communication system or the second communication system.

8. An unmanned aerial vehicle system, comprising: an unmanned aerial vehicle and a remote control, wherein:
the unmanned aerial vehicle includes:
a camera configured to capture an image or video,
a first communication system configured to communicate according to a proprietary protocol,
a second communication system configured to communicate according to a standard communication protocol, and
a controller configured to control operations of the first communication system and the second communication system, to allow the first communication system and the second communication system to simultaneously transmit the image or video captured by the camera; and
the remote control is configured to receive, from the unmanned aerial vehicle, the image or video captured by the camera by communicating with the first communication system and/or the second communication system of the unmanned aerial vehicle.

9. The unmanned aerial vehicle system according to claim 8, wherein:
the controller is configured to control the operations of the first communication system and the second communication system such that one of the first communication system and the second communication system transmits the image or video captured by the camera to the remote control, and the other of the first communication system and the second communication system transmits the image or video captured by the camera to a second device.

10. The unmanned aerial vehicle system according to claim 8, wherein:
the first communication system and the second communication system operate on different frequency bands.

11. The unmanned aerial vehicle system according to claim 9, wherein:
the second device includes a user device having an application capable of communicating with the first communication system or the second communication system.

12. The unmanned aerial vehicle system according to claim 9, wherein the remote control is further configured to:
transmit an image or video, received from the unmanned aerial vehicle, to the second device; or
receive, from the second device, an image or video received by the second device from the unmanned aerial vehicle.

13. A method implemented by an unmanned aerial vehicle, the unmanned aerial vehicle comprising a camera, a first communication system, a second communication system, and a controller, and the method comprising:
capturing an image or video by the camera;
performing communication by the first communication system according to a proprietary protocol;
performing communication by the second communication system according to a standard communication protocol; and
controlling operations of the first communication system and the second communication system by the controller, so that the first communication system and the second communication system simultaneously transmit the image or video captured by the camera.

14. The method according to claim 13, wherein:
the controller controls the operations of the first communication system and the second communication system such that one of the first communication system and the second communication system transmits the image or video captured by the camera to a first device, and the other of the first communication system and the second communication system transmits the image or video captured by the camera to a second device.

15. The method according to claim 13, wherein:
the first communication system and the second communication system operate on different frequency bands.

16. The method according to claim 13, wherein:
the proprietary protocol includes an OcuSync communication protocol, and the standard communication protocol includes a WiFi communication protocol.

17. The method according to claim 14, wherein:
the first device includes a remote control for controlling the unmanned aerial vehicle.

18. The method according to claim 14, wherein:
the second device includes a user device having an application capable of communicating with the first communication system or the second communication system.

19. The method according to claim 16, wherein a 2.4 GHz frequency band is used for OcuSync communication, while a 5.8 GHz frequency band is used for WiFi communication.

20. The method according to claim 16, wherein a 2.4 GHz frequency band is used for WiFi communication, while a 5.8 GHz frequency band is used for OcuSync communication.
